(19) United States
(12) Patent Application Publication
(10) Pub. No.: US 2026/0244179 A1
(43) Pub. Date: Aug. 20, 2026

(54) CONTROLLING MULTIPLE UNITS BY MEANS OF A HIGHER-LEVEL CONTROL DEVICE

(71) Applicant: p&e power&energy GmbH, Kassel (DE)

(72) Inventors: Koenraad Muyllaert, Kassel (DE); Max Rothenburger, Fuldatal (DE)

(21) Appl. No.: 19/643,109

(22) Filed: Apr. 9, 2026

Related U.S. Application Data
(63) Continuation of application No. PCT/EP2024/078206, filed on Oct. 8, 2024.

(30) Foreign Application Priority Data
Oct. 13, 2023 (DE) 10 2023 128 073.2

(51) Int. Cl. G05B 19/042

(52) U.S. Cl. CPC G05B 19/0423; G05B 2219/2231; G05B 2219/25257

(57) ABSTRACT

For controlling multiple units by means of a higher-level control device, reference values are sent by the control device to the units, each reference value being individually assigned to one of the units. In each of the units, the assigned reference value is received and stored. In all units, counter values are set to an identical initial value. First and second count signals are sent by the control device to the units, the count signals being the same for all units. The count signals are received in the units. In each unit, the counter value is increased by an identical fixed increment amount upon receiving each first count signal and decreased by an identical fixed decrement amount upon receiving each second count signal. A present target state of each of the units is determined in the same manner by comparing its reference value with the present counter value.

### CROSS REFERENCE TO RELATED APPLICATIONS

This application is a continuation of International Application PCT/EP2024/078206 with an international filing date of October 8, 2024, entitled “Method, Computer Program and Device for Controlling Multiple Units by Means of a Master Controller” and claiming priority to German patent application DE 10 2023 128 073.2 filed October 13, 2023 and entitled “Verfahren, Computerprogramm und Vorrichtung zum Steuern mehrerer Einheiten mittels einer übergeordneten Steuerung”.

### FIELD OF THE INVENTION

The present invention relates to a method for controlling multiple units by means of a higher-level control device, and to an apparatus comprising multiple units and a higher-level control device.

For example, the units may be individual batteries or other voltage sources with associated full bridges of a modular multilevel converter that are connected in series with one another and are controlled by the higher-level control device in order to output a constant DC voltage or a defined AC voltage.

### BACKGROUND OF THE INVENTION

European patent application publication EP 2 945 273 A1 and United States patent US 9,680,392 belonging to the same patent family disclose a modular multilevel converter. The converter has a plurality of units each having a power-electronic circuit to which one of a plurality of voltage sources can be connected, and a central controller. The central controller assigns ascending addresses to the units and actuates the units in the order of these addresses. Specifically, the power-electronic circuits have three different switching states in order to discharge, bypass or charge a capacitor of the respective voltage source. If a specific output voltage is desired, the controller, starting with the unit having the smallest address, switches as many units into the discharging switching state as are required for providing the specific output voltage. All other power-electronic circuits remain in the bypassing or charging switching states. If, subsequently, another output voltage is desired, the power-electronic circuits last switched into the discharging switching state are switched into the bypassing switching state, and then as many units having the next higher addresses are switched into the discharging switching state as are required for providing the other output voltage, and so on. Correspondingly, for providing negative output voltages, sufficiently many alternating units are each switched into the charging switching state. In this way, the connected voltage sources are intended to be uniformly loaded. However, the actuation of the individual units by the central controller in this way is complex in implementation, in particular if different output voltages are to be realized in rapid succession, as is the case in inverter operation, or if an output voltage is to be kept constant in the event of strongly fluctuating power draw. In addition, the capacitors of the individual voltage sources are each discharged or charged only for very short periods of time, that is to say very many load changes occur. These numerous load changes are necessary on account of the limited capacitance of the capacitors.

International application publication WO 2020/065095 A1 discloses a method for controlling units of a modular multilevel converter by means of a central controller. The units each have a power-electronic circuit for connecting a battery. A plurality of so-called concentrators are each connected between the central controller and a plurality of the units that form a group of units. In each group, one of the units assumes control functions in the implementation of control instructions of the central controller. In this way, safety problems that are said to be associated with a centralized protocol are intended to be eliminated. However, it is not specified how the control instructions of the central controller are implemented exactly in order, for example, to provide specific output voltages by means of the converter.

United States patent application publication US 2013/0223115 A1 and corresponding United States patent US 9,214,871 disclose a power conversion device having a plurality of single-phase power converters with local controllers that are networked to a central control unit via a ring bus. The controllers are assigned ascending numbers corresponding to their placement in the ring, which numbers serve as an address for the assignment of setpoint values. Communication with the central control unit takes place by means of data packets in which the setpoint values are transmitted one after another in ascending order together with the number of the controller.

German patent publication DE 10 2020 118 242 B3 discloses a multilevel inverter for generating a multi-stage output voltage, which inverter has a central device and a plurality of voltage modules controllable by the central device. Activation of the voltage modules is based on a counting operation and the comparison of the count signal with a predefined reference value. The count signal is generated on the respective module and synchronized via a communication line with the counter in further modules and the central device. Both activation and deactivation of the voltage modules take place locally by time control.

Emilia Noorsal et al.: Design of FPGA-Based SHE and SPWM Digital Switching Controllers for 21-Level Cascaded H-Bridge Multilevel Inverter Model, Micromachines 2022, 13, 179 disclose a counting-based "staircase modulation" in a modular current converter with H-bridge modules by means of an FPGA. The counter implemented as an up-counter is part of a central controller. Further, a constant power anemometer (CPA) is known in which the heating rate, i.e. the electrical power being the product of the amperage of the electric current trough the probe and the voltage dropping over the probe, is maintained constant. Here, the flow velocity is derived from a change in the amperage or the voltage.

United States patent application publication US 2010/0185784 A1 discloses an address assignment method in which an address signal sent by a control device via a communication channel is increased by 1 in each unit of a modular system. In that the address signal returning to the controller is increased by the number of units of the modular system, it indicates to the control device that it has been received by all units and that these can in future be addressed with the count signal corresponding to them.

There still is a need of a method for controlling multiple units by means of a higher-level control device and an apparatus comprising multiple units and a higher-level control device in which, despite a high frequency, for example when adjusting to a desired output voltage, the individual units and in particular batteries connected to power-electronic circuits of the individual units are, on the one hand, stressed by load changes as infrequently as possible and, on the other hand, as uniformly as possible.

### SUMMARY OF THE INVENTION

The present invention relates to a method of controlling multiple units by means of a higher-level control device. The method comprises sending reference values from the control device to the units, each of the reference values being individually assigned to one of the units; receiving and storing the assigned reference value in each of the units; setting counter values in all of the units to an identical initial value; and sending first count signals and second count signals from the control device to the units, the first and second count signals being the same for all of the units. The method further comprises receiving the first count signals and the second count signals in each of the units; in each of the units, upon receiving each of the first count signals, increasing the counter value by an identical fixed increment amount; in each of the units, upon receiving each of the second count signals, decreasing the counter value by an identical fixed decrement amount; and determining a present target state of each of the units in a same manner by comparing the respective reference value with the present counter value in the respective unit.

The present invention also relates to an apparatus comprising multiple units and a higher-level control device. The control device stores a first module of instructions that, when executed by the control device, cause the control device to send reference values to the units, each of the reference values being individually assigned to one of the units, to send an initialization signal to the units, and to send first count signals and second count signals to the units, the first count signals and the second count signals being the same for all of the units. Each of the units has a memory and a counter and stores a second module of instructions that, when executed by the respective unit, cause the respective unit to receive and store the reference value individually assigned to the respective unit in the memory of the respective unit, to receive the initialization signal and to set a counter value of the counter of the respective unit to an initial value identical for all units upon receiving the initialization signal, to receive the first count signals and the second count signals, to increase the counter value of the counter of the respective unit by an identical fixed increment amount upon receiving each first count signal, and to decrease the counter value of the counter of the respective unit by an identical fixed decrement amount upon receiving each second count signal, and to determine a present target state of the respective unit by comparing the respective reference value stored in the memory of the respective unit with the present counter value of the counter of the respective unit.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic overview of an apparatus according to the present disclosure.

FIG. 2 is a more detailed schematic view of a unit of the apparatus according to FIG. 1.

FIG. 3A, FIG. 3B, FIG. 3C and FIG. 3D show four different switching states of an actuator of the unit according to FIG. 2.

FIG. 4 is a flow diagram of steps of a method according to the present disclosure that are carried out by a control device of the apparatus according to FIG. 1, and thereby corresponds to a first program module of a computer program according to the present disclosure; and

FIG. 5 is a flow diagram of the steps of the method according to the present disclosure that are carried out in each unit of the apparatus according to FIG. 1, and thereby corresponds to a second program module of the computer program according to the present disclosure.

### DETAILED DESCRIPTION

In a method according to the present disclosure of controlling multiple units by means of a higher-level control device, reference values are sent by the control device to the units, each reference value being individually assigned to one of the units. In each of the units, the assigned reference value is received and stored. Counter values in all units are set to an identical initial value. Then, first count signals and second count signals are sent by the control device to the units, the count signals being the same for all of the units. The count signals are received in each of the units. Upon receiving each first count signal, the counter value in each of the units is increased by an identical fixed increment amount; upon receiving each second count signal, the counter value in each of the units is decreased by an identical fixed decrement amount. Thus, the counter values are always the same in all units, but are available in each of the units in order to determine a present target state of each of the units in a same manner by comparing the respective reference value with the present counter value in the respective unit. In this way, the higher-level control device specifies the target states for the plurality of units. In doing so, with each count signal the present counter value in the units always changes only by the fixed increment amount or the fixed decrement amount and thus comparatively slowly. If the spread of the totality of the reference values for the individual units is much greater than these amounts, the result of comparing the respective reference value with the present counter value in the respective unit therefore changes only for a few units, often for only a single unit. For most units, the target state does not change, so that no load changes occur. By sending new reference values recurring at certain, in particular regular, intervals it can, at the same time be ensured that the units that have more frequently experienced a change of their target state in the past will in the near future belong to the units for which the result of the comparison between the reference value assigned to them and the present counter value, and correspondingly their target state, does not change. Above all, however, the count signals can be transmitted from the control device to the units, registered there and evaluated there in a very simple manner at high frequency, whereby a very rapid actuation of the units and a very high control frequency can be realized.

Typically, the increment amount and the decrement amount are equal, and the reference values differ by integer multiples of the increment amount. However, the latter does not exclude individual ones of the reference values being the same. Thus, for example, the same reference value may always be assigned to two of the units. In this case, these two units always change their present target state jointly. The same reference value may also be assigned to three or more of the units in each case. Preferably, however, each reference value is assigned only once to one of the units. Furthermore, it is preferred if the reference values and the initial value are integer multiples of the increment amount. Conversely, by virtue of the reference value or the initial value differing, for example, by half an increment amount from a multiple of the increment amount, it can be ensured that the counter value and the reference value are never equal, but always differ, so that when comparing the respective reference value with the present counter value either the reference value or the counter value is always greater.

In an embodiment of the method, the reference values follow one another at intervals of one times the increment amount. Furthermore, it proves practical if the reference values and the counter values correspond to integers, whereby, for example, any rounding problems are avoided. This is advantageous in particular if the respective reference value and the present counter value can also be equal and this is to be recognized unambiguously.

In the comparison in the respective unit, it may be determined whether the present counter value is positive or at least not negative and at least one of whether the reference value is greater than the counter value or whether the counter value is greater than the reference value or, if this is possible, whether the reference value and the counter value are equal, in order to obtain a first comparison result. Depending on this first comparison result, it can be determined whether the present target state of the respective unit is a first target state or a target state differing from the first target state and designated here as a third target state. In this case, the case that the reference value and the counter value are equal may optionally be assigned to the first or to the third target state. In principle, however, the case that the reference value and the counter value are equal may also be assigned to a still further target state, which is designated here as a fourth target state. However, this fourth target state is changed again to another target state upon the next change of the counter value, which is less preferred as a tendency unless the fourth target state is a special transitional state between the first target state and the third target state.

Furthermore, in the comparison in the respective unit, it may be determined whether the present counter value is negative or at least not positive and at least one of whether the reference value multiplied by -1 is less than the counter value or whether the counter value is less than the reference value multiplied by -1 or, if this is possible, whether the reference value multiplied by -1 and the counter value are equal, in order to obtain a second comparison result. Depending on this second comparison result, it can then be determined whether the present target state of the respective unit is a second target state or the third target state. As also in the case of the first comparison result, the case that the reference value multiplied by -1 and the counter value are equal may be assigned either to the second target state or to the third target state or to a still further target state designated here as a fifth target state.

Preferably, the assignment of the first and third and, where appropriate, fourth target state takes place symmetrically with respect to the assignment of the second and third and, where appropriate, fifth target state. For example, when the counter value is positive or at least not negative, the present target state is the first target state if the counter value is greater than or equal to the reference value, whereas the present target state is the third state if the reference value is greater than the counter value; and when the counter value is negative or at least not positive, the present target state is the second target state if the counter value is less than or equal to the reference value multiplied by -1, whereas the present target state is the third target state if the reference value multiplied by -1 is less than the counter value. If reference values then increase by 1 in each case starting from 1, a present positive counter value specifies the number of the units that are in the first target state, whereas a negative counter value specifies the number of the units presently in the second target state. The other units each have the third target state; when the counter value is zero, these are all units. In keeping therewith, the first target state may be a state active in one direction, the second target state may be a state active in another direction, in particular opposite to the one direction, and the third target state may be a passive state.

In the method, the control device may also send a shut-off signal to the units, the target state of each of the units being changed immediately to a shut-off state upon receiving the shut-off signal. This may mean that the target state of each of the units, irrespective of the present counter value, becomes an off-state in which, for example, all switches of a power-electronic circuit are open.

In the method, the first count signals and the second count signals may follow one another in any desired sequence. It is preferred if the count signals follow one another at identical intervals. For this purpose, in addition to the first count signals and the second count signals, third count signals may be sent by the control device to the units, the present counter value in each of the units being kept constant upon receiving each third count signal. Thus, the count signals can be sent by the control device to the units at a fixed rate without thereby bringing about unnecessary changes of target states of units as such.

After determination of its present target state, the respective unit is transferred, insofar as this is possible, into a corresponding actual state. This transfer is triggered in the respective unit as a result of the comparison of the reference value with the counter value and is not directly specified by the higher-level control device.

Specifically, the present target state of each unit may be a switching state of a power-electronic circuit of the respective unit. For example, the power-electronic circuit of the respective unit may be connected to a respective current or voltage source/sink, such as for example a battery. Furthermore, the power-electronic circuit may have a half bridge having at least two power switches or a full bridge having at least four power switches, in particular in an H configuration. The power-electronic circuits of the individual units may be electrically connected in series. This would regularly be the case, for example, in a modular multilevel converter. However, individual units - or in other applications all units - may also be connected in parallel.

In an embodiment of the method, the reference values are sent by the control device to the units via a first communication channel, while the count signals are sent by the control device to the units via a second communication channel separate from the first communication channel. An initialization signal for triggering the setting of the counter values in the individual units to the identical initial value can in principle also be sent by the control device to the units via this second communication channel. However, the second communication channel is specialized for the rapidly successive count signals and the initialization signal is needed at most just as frequently as the reference values, so that it is better transmitted, like the reference values, via the first communication channel. Alternatively, each sending of reference values by the control device can be interpreted as an initialization signal, so that no separate initialization signal is required. In an embodiment of the method, new reference values are sent by the control device to the units at certain intervals in order to ensure uniform stressing of the individual units or, for example, batteries connected thereto. A corresponding change rate of the reference values can be in a range from 0.1 Hz to 10 Hz, that is to say can also still be comparatively high, but it is nevertheless always much lower than a signal rate of the count signals, which is in a typical range from 1 kHz to 100 kHz. If the signal rate of the count signals is significantly lower, a significantly lower change rate of the reference values is sensible. If, by contrast, the individual units are not heavily stressed by load changes, the change rate of the reference values may also be somewhat greater, but it always remains smaller than the signal rate and regularly is not more than 10% of the signal rate.

Via the first communication channel, information about the general operating state of the units can be sent from the units to the control device. This information may include the voltage and thus the state of charge of a connected battery, its temperature, or also the present actual state of the units. However, the present actual state of a unit may change with the counter value much more quickly than this can be documented by communication via the first communication channel.

While the first communication channel can in many cases also be configured wirelessly without difficulty, it is preferred to configure at least the second communication channel in wired form. In this case, the individual units can be connected in parallel with one another to the second communication channel so that the count signals arrive at them as simultaneously as possible. However, this is not mandatory if the signal speed via the second communication channel is high compared with the signal rate of the count signals, as will further be explained below.

The various count signals on the second communication channel can, for example, be coded by at least one of different signal pulse widths or different signal edge phases, which can be evaluated very quickly with regard to the presence of the different count signals in order to correspondingly increase, decrease or keep constant the counter value. Corresponding digital and analog circuits for signal evaluation are familiar to the person skilled in the art.

In a preferred embodiment of the method, at least one of the communication channels and preferably the first communication channel and the second communication channel runs from the control device to one of the units, then from unit to unit, and finally from the last of the units back to the control device. If the second communication channel runs in this way, the second communication channel can be interrupted in each of the units in the event of a fault of the respective unit and, thus, this fault case can be signaled to the higher-level control device, which does not receive back the count signal sent by it. Specifically, in each of the units the count signals can run through an AND gate, at the other input of which there is a signal that signals the proper state of the respective unit. At the output of the AND gate the count signals are then present again as long as the respective unit is in the proper state, and the count signals are forwarded, refreshed by the AND gate, to the next unit. If, however, the signal at the second input of the AND gate is absent because a fault is present, the second communication channel is interrupted. If the signal at the second input of the gate is not intended to be lowered but raised in the event of a fault, a NAND gate is to be used instead of the AND gate. In any case, the count signal passing through is refreshed by each gate, which is advantageous in the case of a multiplicity of units. The delay of the count signal by the gates in the units is in a range of 1 ns and is thus not relevant at the signal rates mentioned above, i.e. the count signals arrive in the units simultaneously with respect to the time cycle defined by the signal rate.

If a count value in a count command sent by the control device via the first communication channel is increased in each of the units such that the count command returning to the control device indicates the number of units, which is realized most simply by the count value being increased by 1 in each of the units, the number of units is detected by the control device. In this way, it can be ensured that an assigned reference value is transmitted to each of the units and that all units are uniformly stressed by the regular updating of the reference values.

A computer program for executing the method according to the present disclosure has a first program module for loading into a higher-level control device, the first program module, when processed, causing the control device to carry out the steps of sending of the method according to the present disclosure. Furthermore, the computer program has a second program module for loading into each of the units. When processed, this second program module causes the respective unit to carry out the steps of receiving, storing, setting, increasing, decreasing, determining and comparing of the method according to the present disclosure. The computer program may be stored on any non-transitory computer-readable medium. For example, the computer program may be stored on a portable data carrier or on a data server from which it can be downloaded, e.g. via the internet.

In an apparatus according to the present disclosure for carrying out the method according to the present disclosure, the apparatus comprising multiple units and a higher-level control device, the control device is configured to send reference values to the units, each of the reference values being individually assigned to one of the units, to send an initialization signal and to send first count signals and second count signals to the units, the count signals being the same for all units. The sending of the initialization signal may be identical to the sending of the reference values. Each of the units is configured to receive and store the assigned reference value, to receive the initialization signal and set a counter value to an initial value identical for all units upon receiving the initialization signal, to receive the count signals, increase the counter value by an identical fixed increment amount upon receiving each first count signal and decrease the counter value by an identical fixed decrement amount upon receiving each second count signal, and to determine its present target state by comparing the respective reference value with the present counter value.

The control device may furthermore be configured to send third count signals in addition to the first count signals and the second count signals, each of the units then being configured to keep its present counter value constant upon receiving each third count signal.

Each of the units may be connected to the control device by means of a first communication channel for sending the reference values to the units and a second communication channel for sending the count signals to the units. In this case, each of the units has a first communication interface for connection to the first communication channel for receiving the reference values and a second communication interface for connection to the second communication channel for receiving the count signals. Furthermore, each unit has a controller and an actuator, the respective controller comprising a counter indicating the counter value, and the respective target state of the respective unit being a present target state of its actuator.

At least one and preferably each of the first and the second communication channels runs from the control device to one of the units, then from unit to unit and from the last of the units back to the control device, each first communication interface or each second communication interface of the respective unit correspondingly having both a receiver and a transmitter. Furthermore, each of the units is preferably configured to transmit information about its present operating state to the control device via the first communication channel and to interrupt the second communication channel in the event of a fault. In addition, each of the units may be configured to increase a count value in a count command sent by the control device, so that the count command returning to the control device indicates the number of units.

The actuator of each of the units may have a power-electronic circuit. The power-electronic circuit may be a half bridge or full bridge to which a current or voltage source is connected or can be connected. The power-electronic circuits of the units may be connected to one another in series or in parallel, or groups of the power-electronic circuits may be connected to one another in parallel and these groups of parallel connected power-electronic circuits may be connected to one another in series.

In one specific embodiment of the apparatus, the power-electronic circuit has a half bridge, a first input, a second input and an output. Then, in a first target state of the unit, the first input can be connected to the output, whereas in a second target state of the unit the second input is connected to the output.

In another specific embodiment, the power-electronic circuit of the respective unit has a full bridge, a first input, a second input, a first output and a second output, wherein in a first target state the first input is connected to the first output and the second input is connected to the second output, whereas in a second target state the second input is connected to the first output and the first input is connected to the second output, and in a third target state the first output is connected to the second output. These target states correspond to the basically known operation of a modular multilevel converter.

The controller of the respective unit may be configured as an FPGA (Field Programmable Gate Array) or microcontroller. The actuator may have a power-electronic circuit other than a half bridge or full bridge and, for example, a voltage regulator. The actuator may furthermore have a current valve, such as a transistor or thyristor, but also a hydraulic valve. The current or voltage source connected to the respective power-electronic circuit may be at least one of a source or a sink for the current or the voltage. In particular, the current or voltage source may be both source and sink, such as for example a battery that can both be discharged and recharged. The power-electronic circuits of the units are therefore in particular designed bidirectionally and can moreover be switched into a neutral state, that is to say a state bridging the current or voltage source. Moreover, they may have a shut-off state in which all their switches are open.

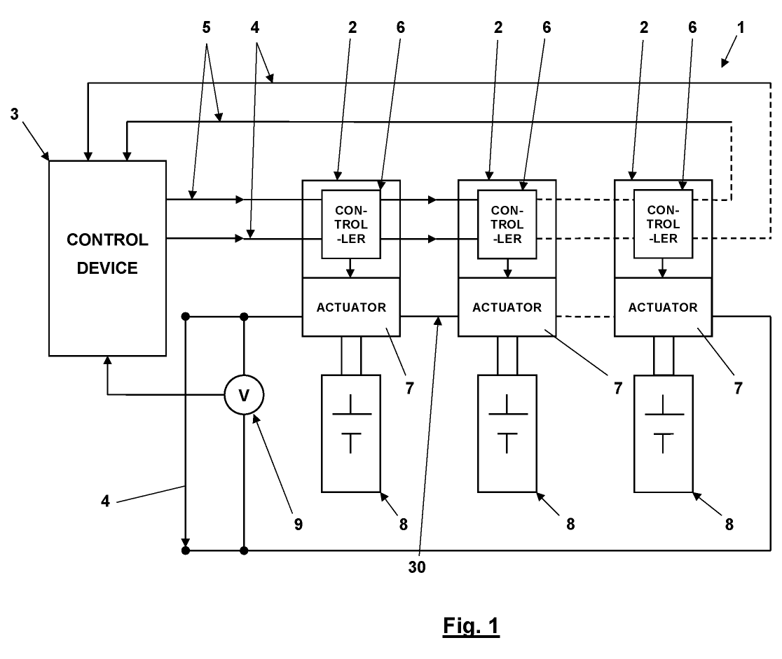

Referring now in greater detail to the drawings, an apparatus 1 illustrated in FIG. 1 has a plurality of units 2 and one higher-level control device 3 for controlling the units 2. While three units 2 are illustrated in FIG. 1, their number may be much greater and may also exceed 100, for example. The control device 3 is connected to the units 2 via two communication channels 4 and 5. The communication channels 4 and 5 each run from the control device 3 to a first of the units 2, then from unit 2 to unit 2 and finally from the last of the units 2 back to the control device 3. The units 2 each comprise a controller 6 and an actuator 7. Here, a battery 8 is connected to each of the actuators 7. In the present example, the batteries 8 can be connected in series with different polarities via the actuators 7, or bypassed, as will be explained in more detail below, in order to provide an output voltage U across their series connection 30. The output voltage U is detected by a voltmeter 9, which is connected for providing a feedback value to the control device 3. The actuators 7 with the connected batteries 8 are only one possible embodiment. Instead, the units 2 may comprise any other power-electronic circuits or, for example, also hydraulic valves. It is typical, however, that the actuators 7 of the units 2 interact to provide an overall result and are controlled for this purpose by the higher-level control device 3.

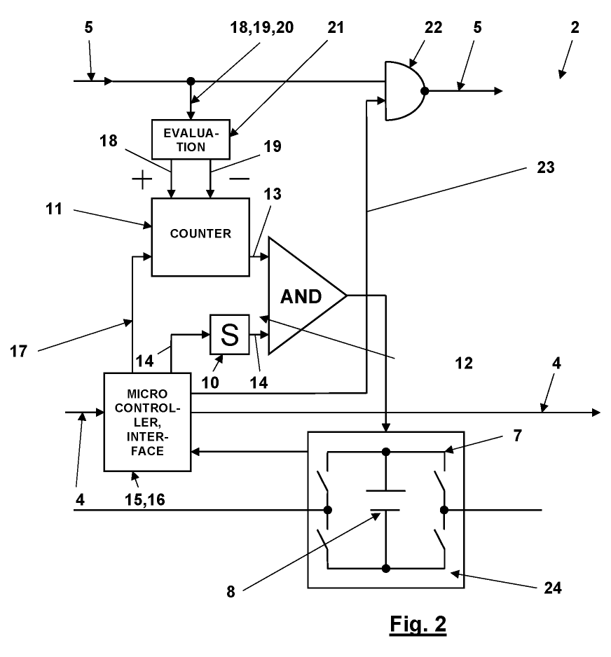

FIG. 2 sketches the internal construction of one of the units 2 according to FIG. 1. The unit 2 has a memory 10 for a reference value 14 and a counter 11 as well as a comparator 12 that compares a present counter value 13 of the counter 11 with the reference value 14 stored in the memory 10. Depending on the comparison, the actuator 7 is actuated. More precisely, on the basis of the comparison a target state of the actuator 7 is determined, and the actuator 7 is actuated such that its actual state corresponds to the target state. Via the communication channel 4, also designated as the first communication channel, the reference value 14 is transmitted to the respective unit 2 and then stored in its memory 10. The reference value 14 is a value that is individually assigned to the respective unit 2. In order to enable this assignment, a count command can first be transmitted via the first communication channel 4. This count command contains a variable that describes the number of units 2 that the count command has already reached. When this count command arrives at one of the units 2, the unit increments the number of units by one and registers the resulting increased number as the number of the unit along the first communication channel 4 in a microcontroller 15, which at the same time constitutes a first communication interface 16 for connection to the first communication channel 4. In this way, the higher-level control device 3 can address the respective unit 2 via its number in the sequence of the units 2; and conversely, the respective unit 2 can, with information about its operating state that it transmits via the communication channel 4, allocate itself by specifying its number. In principle, however, the higher-level control device 3 can also address the individual units 2 with their respective ID addresses if these are entered by the individual units, for example, into the count command running via the first communication channel 4. The information about the operating state of the unit 2 may relate, for example, to its actuator 7 or the battery 8 connected thereto. In addition to the reference value 14, which is individually assigned to the unit 2, the unit 2 receives via the first communication channel 4 an initialization signal 17 in order to set the counter value 13 of its counter 11 to an initial value that is the same for all units 2. This initialization signal 17 may be a separate signal, but may also be the reception of the reference value 14. After this preparation, the counter values 13 of all units 2 are identical and the reference values 14 are fixed individually and typically all differently for the individual units 2. As a result, different target states for the actuators 7 of the individual units 2 can already arise, which are then set. Mainly, however, different and temporally variable target states for the individual actuators 7 arise, because count signals 18 to 20 are transmitted via the second communication channel 5, which are analyzed by an evaluation device 21 as to whether they are first count signals 18 that are intended to have the consequence of an increase of the counter value 13 by a fixed increment amount, or second count signals 19 that are intended to have the consequence of a decrease of the counter value 13 by a fixed decrement amount, or third count signals 20 that are intended to have the consequence of no change in the counter value 13. For example, the count signals 18 to 20 may differ by different pulse widths or phase positions. In the unit 2, the count signals 18 to 20 are present at one input of an AND gate 22, at the other input of which there is a signal 23 which signals the proper functioning of the unit 2. Thus, the count signals 18 to 20 are passed through the unit 2 on the second communication channel 5 as long as the unit 2 is functioning properly. If this is not the case, so that the signal 23 falls to zero, the AND gate 22 blocks the forwarding. This is immediately registered by the higher-level control device 3, at which the communication channel 5 ends, so that it recognizes the fault case immediately. More detailed information about the fault case can then be transmitted as part of the information about the operating state of the respective unit 2 transmitted via the communication channel 4. As long as the second communication channel 5 is not interrupted in any of the units 2, the counter values 13 of all counters 11 in all units 2 are identical, a speed of signal transmission via the second communication channel 5 and across the AND gates 22 that is high in comparison with the rate of the count signals 18 to 20 being assumed. The comparison of the counter value 13 with the reference value 14 already addressed can be more comprehensive than is indicated here by the circuit diagram of the comparator 12 in FIG. 2.

Thus, in addition to the comparison of the counter value 13 with the reference value 14, the counter value 13 can be compared with the reference value 14 multiplied by -1. Thus, a positive counter value 13 can have the consequence that the actuators 7 of a number of units 2 corresponding to the counter value 13 are transferred into an actual state in which the voltage of the connected battery 8 increases the output voltage U according to FIG. 1. The actuators of the respectively other units 2 can be transferred into an actual state in which their batteries 8 contribute nothing to the output voltage U. In the case of a negative counter value 13, by contrast, the actuators 7 of as many units 2 as corresponds to the absolute value of the counter value 13 can be transferred into such an actual state that the output voltages of the connected batteries 8 make a negative contribution to the output voltage U, whereas the actuators 7 of the other units 2 are transferred into such an actual state that the connected batteries 8 make no contribution to the output voltage U. In this way, a modular multilevel converter can be formed with the plurality of units 2.

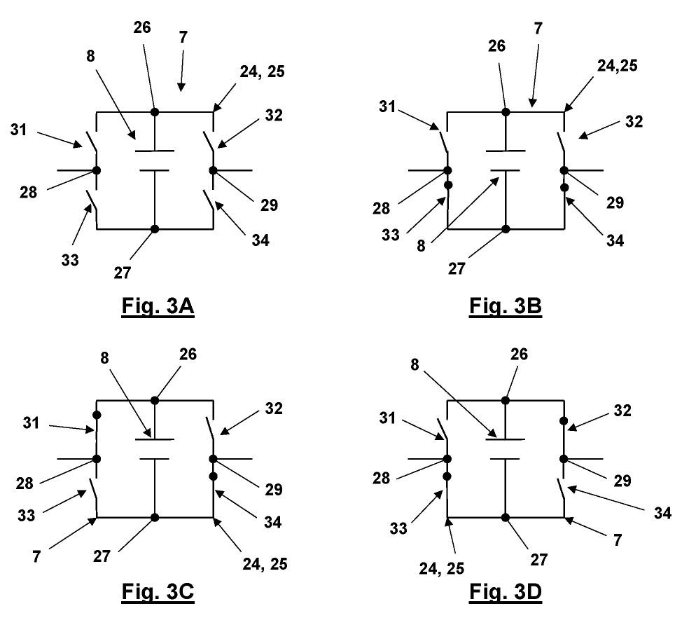

FIG. 3A to FIG. 3D show four possible switching states of a power-electronic circuit 24 that is part of the actuator 7 according to FIG. 2. The power-electronic circuit 24 is a full bridge 25 in H configuration with two inputs 26 and 27, two outputs 28 and 29. The battery 8 is connected to the inputs 26 and 27. Two switches 31 and 32 are arranged between the input 26 and the outputs 28 and 29, and two switches 33 and 34 are arranged between the other input 27 and the outputs 28 and 29. In the switching state according to FIG. 3A, all switches 31 to 34 are open and the series connection 30 is thereby interrupted. This switching state according to FIG. 3A may be the target state of the actuator 7 when a fault case occurs in the unit 2 or when a fault case is signaled to the unit by the control device 3.

In the switching state according to FIG. 3B, the switches 33 and 34 are closed, while the switches 31 and 32 are open. As a result, the battery 8 is bridged or bypassed. This switching state is also referred to as bypass of the battery 8. In this switching state, the battery 8B does not contribute to the output voltage U of the series connection 30 according to FIG. 1. However, the series connection 30 is not interrupted. This switching state is the normal inactive target state of the actuator 7.

In the switching state according to FIG. 3C, the switches 31 and 34 are closed, while the switches 32 and 33 are open. As a result, the battery voltage of the battery 8 contributes positively to the output voltage U of the series connection 30 according to FIG. 1. This switching state is the active target state of the actuator 7 when the reference value 14 is greater than or equal to the counter value 13.

In the switching state according to FIG. 3D, the switches 32 and 33 are closed, while the switches 31 and 34 are open. Thus, the battery with its inverted voltage contributes to the output voltage U of the series connection 30 according to FIG. 1, that is to say it makes a negative contribution to the output voltage U. The switching state according to FIG. 3D is, for example, the target state of the actuator 7 when the reference value 14 multiplied by -1 is less than or equal to the counter value 13.

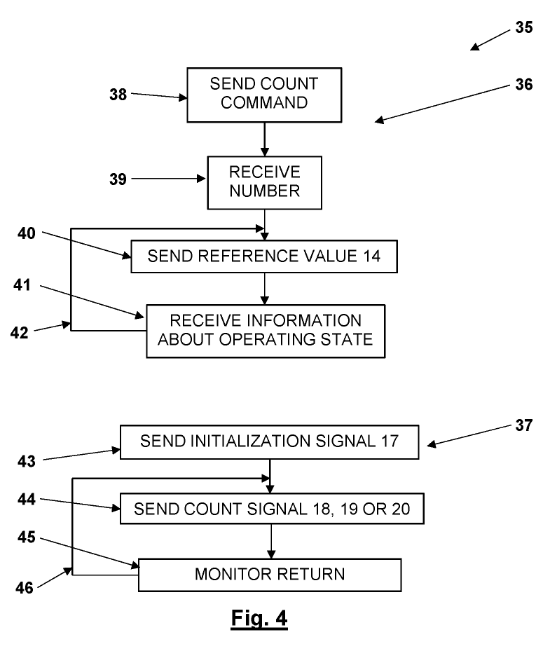

The program module 35 of a computer program shown in FIG. 4 as a flow diagram, which runs in the higher-level device 3 for carrying out the method according to the present disclosure, has two sub-modules 36 and 37. The sub-module 36 concerns the communication via the first communication channel 4, and the sub-module 37 concerns the communication via the second communication channel 5. The sub-module 36 comprises a step 38 of sending the count command to the units 2 arranged one behind another along the first communication channel 4, and a step 39 of receiving the number of units 2 from the count command returning on the first communication channel 4. In a subsequent step 40, the individually assigned reference values 14 are sent via the first communication channel 4 to the units 2. In a step 41, information about the operating state is received from the individual units 2 via the first communication channel 4. A loop 42 leads back to step 40 when new reference values 14 are sent to the units 2. The loop 42 and thus the transmission of the new reference values 14 take place at a typical rate on the order of 1 Hz, for example at a rate of 0.5 Hz. In each run of the loop 41, the reference values 14 are reassigned in such a way that all units 2 and in particular the associated batteries 8 are uniformly stressed and thus, for example, are uniformly discharged and subjected to load changes.

The sub-module 37 comprises a step 43 of sending the same initialization signal 17 via the second communication channel 5 to all units. After this step 43 or the processing of the initialization signal 17 in all units 2, the counter values 13 in all units 2 are equal. But as a rule, after step 40 or the storage of the reference values 14 in all units 2, different reference values 14 are stored. In a following step 44, a count signal 18, 19 or 20 is sent to the units 2. In a following step 45, it is monitored that the count signals 18, 19 and 20 respectively run back to the higher-level control device 3, which signals that no fault case is present in any of the units. A loop 46 leads back to step 44. The loop 46 and thus the sending of the count signals 18 to 20 via the second communication channel 5 take place at a comparatively high signal rate of a typical order of magnitude of 10 kHz. The sub-modules 36 and 37 can be processed alternately or in parallel with one another in the control device 3.

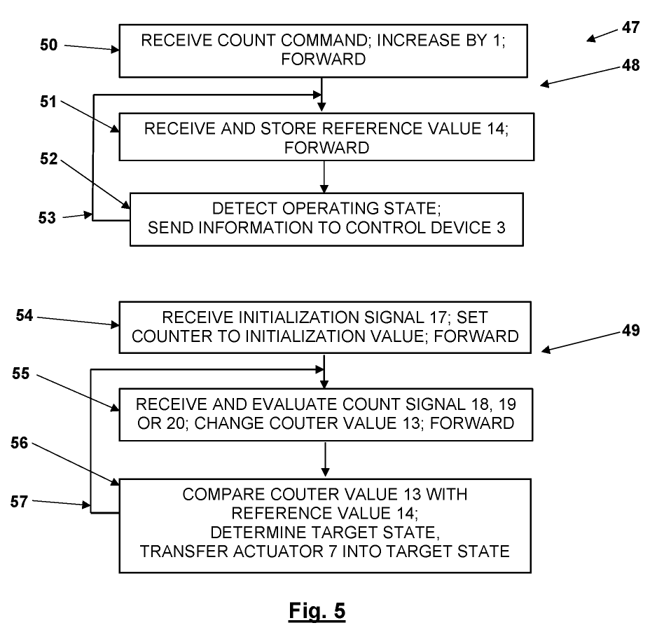

The program module 47 of the computer program shown in FIG. 5 as a flow diagram likewise has two sub-modules 48 and 49, the sub-module 48 concerning the communication via the first communication channel 4 and the sub-module 49 concerning the communication via the second communication channel 5. The sub-module 48 begins with a step 50 of receiving the count command, increasing the included number of units by one, and forwarding the count command. In addition, the number of units increased by one may be noted in the respective unit 2 as its address for the assignment of reference values 14. In a step 51, the receiving of the reference values 14, the storing of the reference value 14 belonging to the respective unit 2, and the forwarding of at least the other reference values 14 to the further units 2 follow. In a step 52, the detection of the operating state of the respective unit 2 and the sending of corresponding information via the first communication channel 4 to the higher-level control device 3 take place. Step 52 can be repeated before a loop 53 begins again with step 51 and the reception and storage of a new reference value 14 in the respective unit 2.

The sub-module 49 comprises a step 54 of receiving the initialization signal 17, setting the counter 11 to the initialization value that is the same for all units 2, and forwarding the initialization signal 17 to the further units 2. In a step 55, one of the count signals 18 to 20 is then received from the control device 2 and evaluated. Depending on the respective count signal, the counter value 13 is changed. Insofar as no fault case of the respective unit 2 is present, the count signal 18, 19 or 20 is refreshed with the aid of the AND gate 22 and forwarded to the next unit 2. This takes place so quickly that the count signals 18 to 20 arrive at all units 2 quasi-simultaneously with respect to the signal rate. In a step 56, the present counter value 13 is compared with the reference value 14 and, on that basis, the target state of the respective actuator 7 is determined, which is then transferred into this target state. A program loop 57 then begins again with step 55 and the reception of the next count signal 18, 19 or 20.

Via the count signals 18 to 20, the higher-level control device 3 controls the individual units 2 in a simple manner with a very high control frequency with respect to the output voltage U. The second communication channel 5 is coordinated to this. The communication via the first communication channel 4, by contrast, takes place at a much lower frequency, but this is sufficient for updating the reference values 14 and transmitting the information about the operating states of the individual units 2.

Many variations and modifications may be made to the preferred embodiments of the invention without departing substantially from the spirit and principles of the invention. All such modifications and variations are intended to be included herein within the scope of the present invention, as defined by the following claims.

I claim:

1. A method of controlling multiple units by means of a higher-level control device, the method comprising
sending reference values from the control device to the units, each of the reference values being individually assigned to one of the units;
receiving and storing the assigned reference value in each of the units;
setting counter values in all of the units to an identical initial value;
sending first count signals and second count signals from the control device to the units, the first and second count signals being the same for all of the units;
receiving the first count signals and the second count signals in each of the units;
in each of the units, upon receiving each of the first count signals, increasing the counter value by an identical fixed increment amount;
in each of the units, upon receiving each of the second count signals, decreasing the counter value by an identical fixed decrement amount; and
determining a present target state of each of the units in a same manner by comparing the respective reference value with the present counter value in the respective unit.

2. The method of claim 1,
wherein the increment amount and the decrement amount are equal, and
wherein the reference values differ by integer multiples of the increment amount.

3. The method of claim 1,
wherein the reference values follow one another at intervals of one times the increment
amount.

4. The method of claim 1,
wherein the step of comparing the respective reference value with the present counter
value in the respective unit comprises
determining whether the present counter value is positive or at least not negative,
and determining at least one of
whether the reference value is greater than the counter value,
whether the present counter value is greater than the reference value, or
whether the reference value and the counter value are equal,
in order to obtain a first comparison result,
determining whether the present counter value is negative or at least not positive,
and determining at least one of
whether the reference value multiplied by -1 is less than the counter value,
whether the counter value is less than the reference value multiplied by -1, or
whether the reference value multiplied by -1 and the counter value are equal,
in order to obtain a second comparison result,
determining, depending on the first comparison result, whether the present target state of
the respective unit is a first target state or a third target state, and
determining, depending on the second comparison result, whether the present target state of the
respective unit is a second target state or the third target state.

5. The method of claim 4, wherein the first target state is a first active state active in one
direction, the second target state is a second active state active in another direction opposite to
the one direction, and the third target state is a passive state.

6. The method of claim 1 further comprising
sending third count signals from the control device to the units,
receiving the third count signals in each of the units;
in each of the units, upon receiving each of the third count signals, keeping the counter value constant.

7. The method of claim 6, further comprising keeping constant a total count signal rate of the first count signals, the second count signals and the third count signals.

8. The method of claim 1, further comprising transferring each of the units into an actual state corresponding to its present target state.

9. The method of claim 8, wherein the present target state is a switching state of a power-electronic circuit of the respective unit.

10. The method of claim 9, wherein the power-electronic circuit of the respective unit is
connected to at least one of a current source, a voltage source, a current sink or a voltage sink.

11. The method of claim 9, wherein the power-electronic circuit of the respective unit has a full bridge, a first input, a second input, a first output and a second output, wherein, in a first target state, the first input is connected to the first output and the second input is connected to the second output, wherein, in a second target state, the second input is connected to the first output and the first input is connected to the second output, and wherein, in a third target state, the first output is connected to the second output.

12. The method of claim 9, wherein at least some of the power-electronic circuits of the units are connected in series.

13. The method of claim 1, further comprising
sending the reference from the control device via a first communication channel to the
units, and
sending the first count signals and the second count signals from the control device via a second communication channel, separate from the first communication channel to the units.

14. The method of claim 13, further comprising
sending new reference values from the control device via the first communication channel
to the units at a change rate in a range from 0.1 Hz to 10 Hz, and
sending information concerning an operating state of the units from the units via the first communication channel to the control device.

15. The method of claim 13, wherein at least one of the first communication channel or the second communication channel is wired.

16. The method of claim 13, wherein the units are connected in parallel with one another to the second communication channel.

17. The method of claim 7, wherein the total signal rate is in a range from 1 kHz to 100 kHz, the method further comprising coding the first count signals, the second count signals and the third count signals by at least one of different signal pulse widths or different signal edge phases.

18. The method of claim 13, wherein at least one of the first communication channel or the second communication channel runs from the control device to one of the units, then from unit to unit, and from the last of the units back to the control device, the method further comprising interrupting the second communication channel in each of the units in the event of a fault of the respective unit.

19. The method of claim 18, further comprising sending a count value in a count command from the control device via the first communication channel and increasing the count value in the count command in each of the units such that the count command returning to the control device indicates the number of units.

20. An apparatus comprising multiple units and a higher-level control device,
wherein the control device stores a first module of instructions that, when executed by the
control device, cause the control device
to send reference values to the units, each of the reference values being individually
assigned to one of the units,
to send an initialization signal to the units, and
to send first count signals and second count signals to the units, the first count signals and
the second count signals being the same for all of the units; and
wherein each of the units has a memory and a counter and stores a second module of
instructions that, when executed by the respective unit, cause the respective unit
to receive and store the reference value individually assigned to the respective unit in the
memory of the respective unit,
to receive the initialization signal and to set a counter value of the counter of the respective
unit to an initial value identical for all units upon receiving the initialization signal,
to receive the first count signals and the second count signals, to increase the counter
value of the counter of the respective unit by an identical fixed increment amount upon receiving
each first count signal, and to decrease the counter value of the counter of the respective unit by
an identical fixed decrement amount upon receiving each second count signal, and
to determine a present target state of the respective unit by comparing the respective
reference value stored in the memory of the respective unit with the present counter value of the
counter of the respective unit.
